(19) United States
(12) Patent Application Publication
(10) Pub. No.: US 2008/0285729 A1
(43) Pub. Date: Nov. 20, 2008

(54) Communication Modalities Management

(76) Inventors: Jay Glasgow, Acworth, GA (US); Adrian Popescu, Marietta, GA (US); Ryan Patrick Swanson, Atlanta, GA (US)

Correspondence Address: HOPE BALDAUFF HARTMAN, LLC, 1720 PEACHTREE STREET, N.W, SUITE 1010, ATLANTA, GA, 30309, US

(21) Appl. No.: 11/749,378

(22) Filed: May 16, 2007

(51) Int. Cl. H04M 11/00

(52) U.S. Cl. 379/88.13

(57) ABSTRACT

Apparatus, systems, methods, and computer-readable media provide for the management of communication modes to facilitate network communications. According to various embodiments described herein, any number of communication methods are categorized into communication modes and communication types. A party sending a communication may choose a method of communicating with a receiving party according to the desired communication mode and type. A network communication application determines the proper routing for the communication according to any number of communication rules and presence information associated with the receiving party.

### TECHNICAL FIELD

This application relates generally to enabling communication between parties over a network. More particularly, this application relates to determining communication modes according to receiver presence information and communication modality rules established by the sending and/or the receiving party.

### BACKGROUND

There are many different modes of communication commonly used today. Examples include but are not limited to face-to-face communication, mail, telephones, electronic mail (email), text messaging, instant messaging, video conferencing, and recorded messages. When a sending party (sender) who wishes to initiate a conversation with a receiving party (receiver), the sender makes the decision as to which communication mode to use. The sender may decide to place a telephone call, for example. By picking up a telephone and dialing the telephone number corresponding to the receiver, the sender has control over how the communication will take place, specifically via a real-time, bi-directional conversation over a telecommunications network.

However, if the receiver is not in the vicinity of the called telephone, then the attempted communication will fail. To make further attempts to contact the receiver, the sender must continue to call other telephone numbers corresponding to the receiver or attempt another mode of communication, such as instant messaging or email, until the receiver is contacted. All applicable telephone numbers and other contact information corresponding to all of the available communication devices for a given receiver are typically stored in an address book or contact list on a personal computer, personal data assistant, telephone, and/or other communications device belonging to the sender. Due to the increasing number of communication devices owned by people, and due to a potentially large number of contacts, this list of contact information can become overwhelmingly large and cumbersome.

### SUMMARY

It should be appreciated that this Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Apparatus, systems, methods, and computer-readable media are provided herein for managing communication modalities to facilitate communications between a sender and a receiver. According to embodiments described herein, a communication request is received from a sender device. A communication mode for communicating with a corresponding receiver device is selected utilizing at least one communication rule. A communications link between the sender device and the receiver device is established utilizing the selected communication mode.

According to further embodiments of the disclosure provided herein, the communication request may include a communication rule associated with the sender that specifies a desired communication mode and/or a conversation type. The conversation type may specify a real-time conversation or a cached conversation. Additional embodiments provide for at least one communication rule that may include a communication rule associated with the receiver. A determination is made as to whether a communication rule associated with the receiver and a communication rule associated with the sender can both be satisfied to select the appropriate communication mode to be used in establishing the communications link between the sender device and the receiver device. If the two rules can both be satisfied, then the communication mode for communicating with the receiver is selected according to both rules. If both rules cannot be satisfied, then the communication mode is selected according to the communication rule associated with the receiver.

Further embodiments include a sender communication device for communicating with any number of receiver communication devices. The sender communication device includes a display, a communication application, and a processor for executing the communication application. The communication application provides a graphical user interface (GUI) to a sender via the display of the sender communication device. The GUI has multiple communication mode selections associated with the receiver communication devices. Each communication mode selection includes a real-time conversation type selection and a cached conversation type selection.

Other apparatus, systems, methods, and/or computer program products according to embodiments will be or become apparent to one with skill in the art upon review of the following drawings and Detailed Description. It is intended that all such additional apparatus, systems, methods, and/or computer program products be included within this description, be within the scope of the present invention, and be protected by the accompanying claims.

### BRIEF DESCRIPTION OF THE DRAWINGS

FIG. 1 is a block diagram showing elements of an illustrative communication system according to various embodiments presented herein;

FIG. 2 is a flow diagram illustrating a method for enabling communication between a sender device and a receiver device according to various embodiments presented herein;

FIGS. 3A-3C are user interface diagrams illustrating graphical user interfaces used to facilitate the initiation of a communications session according to various embodiments presented herein; and

FIG. 4 is a computer architecture diagram showing a computer architecture suitable for implementing the various computer systems described herein.

### DETAILED DESCRIPTION

The following detailed description is directed to apparatus, systems, methods, and computer-readable media for facilitating network communications between a sender and a receiver. While the subject matter described herein is presented in the general context of program modules that execute in conjunction with the execution of an operating system and application programs on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

The subject matter described herein may be practiced in a distributed computing environment where tasks are performed by remote processing devices that are linked through a communications network and wherein program modules may be located in both local and remote memory storage devices. It should be appreciated, however, that the implementations described herein may also be utilized in conjunction with stand-alone computer systems and other types of computing devices.

As discussed briefly above, in a typical communications scenario, the sender controls the mode of communication used to contact a receiver. The sender determines how to contact the receiver and attempts to establish a communication link with a specific device or via a specific communication mode associated with the receiver. As the number of communications devices that an average person owns or has access to increases, it becomes increasingly difficult to know how a person may be contacted. For example, a sender wanting to contact a receiver might first dial a telephone number corresponding to the receiver's home telephone. If unable to contact the receiver, the sender might next dial a telephone number corresponding to the receiver's cellular telephone. Next, the sender might attempt contact via an instant messaging (IM) application. Next, the sender might send the receiver an email. To ensure the receiver gets the message, the sender might finally call back one or more of the telephone numbers to leave a voice message for the receiver.

In all of these example communication attempts, the sender must be able to locate a number, address, or other identifier corresponding to the sender in order to call, message, or email the receiver. All of this contact information is typically stored in a paper or electronic address book associated with the sender, along with the contact information for any number of other parties with which the sender regularly communicates. Sorting through all of this contact information each time the sender attempts to contact a receiver via a different mode of communication can be cumbersome.

If the sender knows that the receiver is available via a particular communication mode then contacting the receiver becomes easier. For example, if the sender knows that the receiver is in possession of a cellular telephone, then the sender is able to look up the corresponding cellular telephone number and attempt to call the receiver with a high probability of success since the receiver is known to be in possession of the cellular telephone being called. Throughout this disclosure, the availability of a receiver and/or the ability and willingness to communicate is referred to as “presence.” Additionally, it should be understood that for the purposes of this disclosure, a communication mode includes all communication devices, communication methods, and communication transports for enabling communication between two or more parties for a given category of communication.

The presence of a receiver is sometimes tracked and available to a sender. An example of when a sender might have knowledge as to the presence of a receiver is when communicating with the receiver via an IM application. Many IM applications allow a sender to view the online/offline status of persons in their buddy list. If a person is online, then the sender at least knows that the person has logged into the IM application. However, an online presence does not necessarily mean that the receiver is available for a conversation. Rather, the receiver may have logged into the IM application and subsequently stepped away from the application or left the area without having logged out of the application.

The ability to determine the presence of a receiver may be based on the physical location of the receiver, whether the receiver has logged into a device or application, whether the receiver has used or is using a particular device or application, and whether the receiver is communicating on or logged into a particular network. A presence determination may be made according to the Session Initiation Protocol (SIP) and via an IP Multimedia Subsystem (IMS) network architecture. In this manner, multiple communication devices and network elements may detect the presence of a receiver and notify a communication management server or other network entity as to the presence status of the receiver. Any changes to the presence status are stored on a network element where they may be accessed by a communication device or communication application. According to embodiments described herein, presence information may be published in an electronic contact list such as an address book, either on a local communication device or on a network element, allowing a sender to more accurately determine the proper communication mode to choose in order to increase the likelihood of successfully contacting a receiver. However, publishing this information for every available communication mode for every contact in the contact list greatly increases the complexity and size of the contact list.

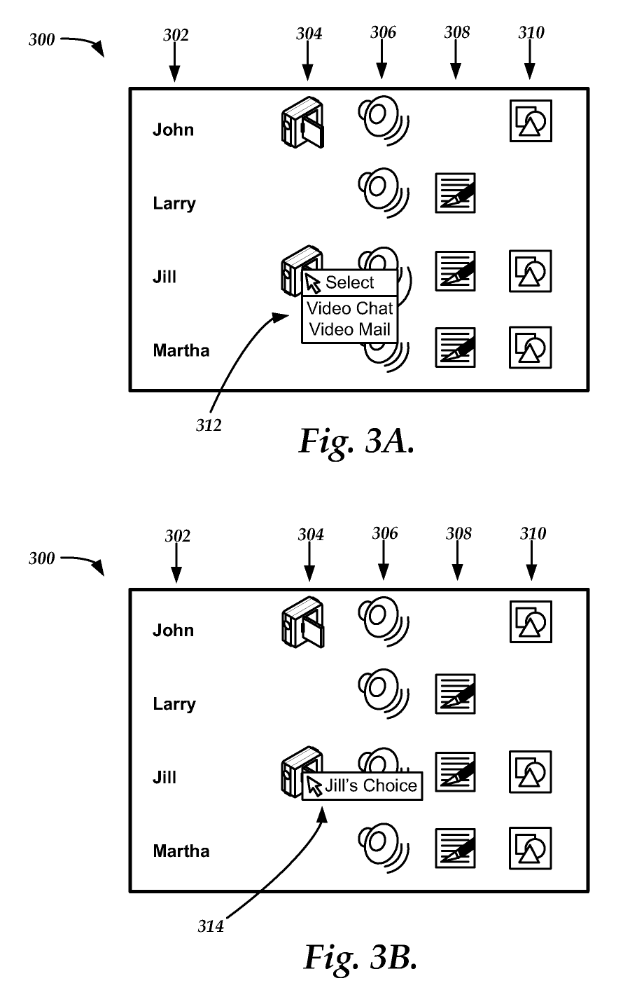

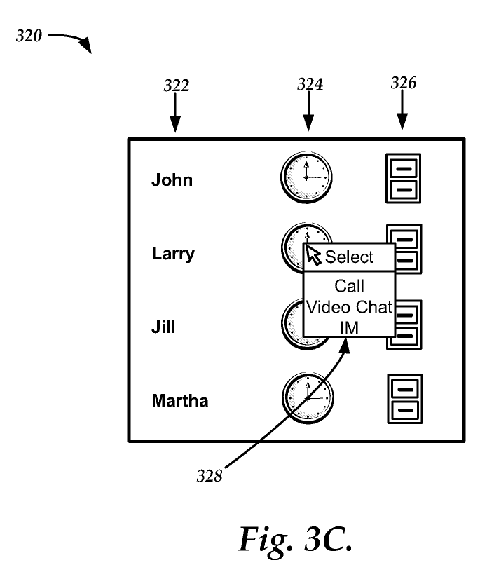

Various embodiments of the disclosure presented herein provide a sender with an efficient method for communicating with a receiver. The sender is presented with a simplified GUI to select a communication mode and a communication type. Sample GUIs illustrating the communication mode selection process will be described below with respect to FIGS. 3A-3C. Embodiments described herein categorize the large number of potential communication modes into the following four selections: audio/visual, audio only, text, and visual only. It should be appreciated that any number of communication mode categories may be used without departing from the scope of this disclosure. The audio/visual category encompasses communication modes such as video conferencing that transmit and receive both audio and video data. The audio only category encompasses communication modes such as telephone communication that transmit and receive only audio data. The text category encompasses communication modes such as email that transmit and receive only textual data. The visual only category encompasses communication modes wherein the sender is requesting stored or real-time visual information such as receiver presence information, biographical information associated with the receiver, or a map.

Embodiments described herein further categorize the communication modes into the following two communication types: real-time communication and cached communication. Real-time communication refers to a bi-directional conversation wherein each party receives any communication from another party substantially as the communication is sent. Very little time elapses between sending and receiving communications. Real-time conversations occur at the same rate as if the parties were communicating face-to-face. Examples include telephone conversations and IM conversations. In contrast, cached communication involves some period of time between the instant that a communication is transmitted until the instant that the receiving party receives the communication. Each communication is placed in a cache until the receiver has an opportunity to receive the message. Examples include email and voicemail. To initiate a communication, a sender selects a desired communication mode and communication type. This selection by the sender may be referred to below as a sender communication rule or a sender rule. A network communication application may determine a communication mode and establish the desired communication according to receiver presence information and any applicable sender rule, as well as any applicable receiver and network rules, as will be described in detail below.

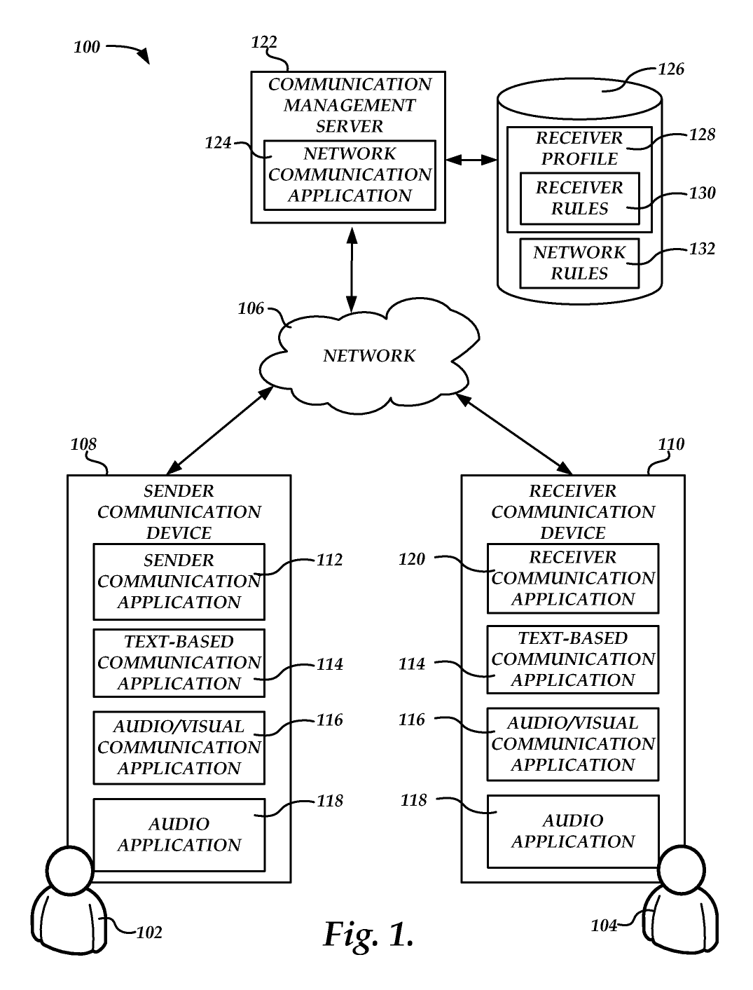

In the following detailed description, references are made to the accompanying drawings that form a part hereof, and which are shown by way of illustration specific embodiments or examples. Referring now to the drawings, in which like numerals represent like elements through the several figures, aspects of a communication modalities management system will be described. FIG. 1 shows various elements of a communication modalities management system 100 according to embodiments described herein. Utilizing the communication modalities management system 100, a sender 102 may communicate with a receiver 104 over a network 106. The communication modalities management system 100 includes a sender communication device 108, a receiver communication device 110, and a communication management server 122.

It should be understood that the sender communication device 108 and the receiver communication device 110 may each be any type of communication device, including but not limited to a personal computer, a cellular telephone, a personal data assistant, a television, a set-top television box, a digital video recorder, a music or other audio device, a video game console, or any other communications device capable of transmitting and/or receiving data via a network 106. The elements of the communication modalities management system 100 communicate with one another via the network 106. It should be understood that the network 106 may include a wireless network such as, but not limited to, a Wireless Local Area Network (WLAN) such as a WI-FI network, a Wireless Wide Area Network (WWAN), a Wireless Personal Area Network (WPAN) such as BLUETOOTH, a Wireless Metropolitan Area Network (WMAN) such a WiMAX network, a cellular network, or a satellite network. The network 106 may also be a wired network such as, but not limited to, a wired Wide Area Network (WAN), a wired Local Area Network (LAN) such as the Ethernet, a wired Personal Area Network (PAN), or a wired Metropolitan Area Network (MAN). The network 106 may also include the Internet such that the network communications occur via wireless or wired connections to the Internet.

The sender communication device 108 includes one or more applications for enabling communications with the receiver communication device 110. According to one embodiment, the sender communication device 108 includes a sender communication application 112, a text-based communication application 114, an audio/visual communication application 116, and an audio application 118. The text-based communication application 114 includes any application that supports transmitting and receiving text communications, including but not limited to an email application, an IM application, and a text messaging or other Short Message Service (SMS) application. The audio/visual communication application 116 includes any application that supports transmitting and receiving audio and/or video communications, including but not limited to a video conferencing application, a video chat application, and a video mail application. The audio application 118 includes any application that supports transmitting and receiving audio. Examples include telecommunications application that transmit and receive audio via a telecommunications network, including but not limited to landline and cellular telecommunications applications.

The sender communication application 112 is a communication application that operates in conjunction with or in place of the text-based communication application 114, the audio/visual communication application 116, and the audio application 118 (communication applications 114, 116, 118). The sender communication application 112 may provide a single application that is operative to provide the sender 102 with a single interface for communicating via any communication mode. As an example, to communicate with the receiver 104, the sender 102 may execute the sender communication application 112 and select a communication mode from a GUI provided by a network communication application 124 or by the sender communication application 112. This selection will be described in detail below with respect to FIGS. 3A and 3B. Upon selecting the communication mode, the sender communication application 112 operates in a similar manner as an applicable communication application 114, 116, 118. For example, if the selected communication mode utilizes email communication, then the sender communication application 112 operates in the same manner that the text-based communication application 114 would operate to send the desired email to the receiver 104.

Alternatively, the sender communication application 112 may provide an interface between the sender 102 and the communication applications 114, 116, 118. For example, to communicate with the receiver 104, the sender 102 may execute the sender communication application 112 and select a communication mode via the GUI provided by the network communication application 124 or by the sender communication application 112. Upon selecting a communication mode that utilizes email communication, then the sender communication application 112 launches the text-based communication application 114 to draft and send the desired email to the receiver 104.

The receiver communication device 110 includes one or more applications for enabling communications with the sender communication device 108. According to one embodiment, the receiver communication device 110 includes a receiver communication application 120 and the communication applications 114, 116, 118. Similar to the sender communication application 112, the receiver communication application 120 is a communication application that operates in conjunction with or in place of the communication applications 114, 116, 118. It should be understood that the sender communication application 112 and the receiver communication application 120 may be identical communication applications operating on different devices or may be different communication applications that provide similar functionality to their respective devices. For instance, each of the communication devices 108 and 110 may contain both the sender communication application 112 and the receiver communication application 120 so that the communication devices 108 and 110 can both send and receive communications using any of the communication applications 114, 116, and 118.

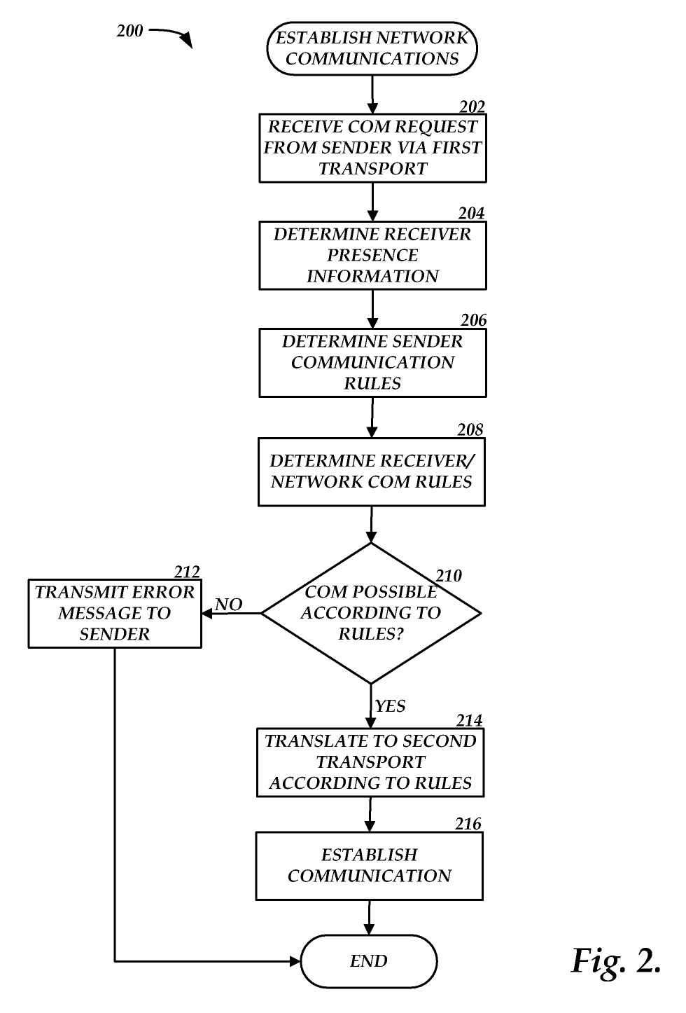

The communication management server 122 is a server computer that includes the network communication application 124 for communicating with the sender communication application 112 and the receiver communication application 120 of the sender communication device 108 and the receiver communication device 110, respectively. The network communication application 124 additionally stores and retrieves receiver rules 130 and network rules 132 to and from a repository 126. The network communication application 124 analyzes the receiver rules 130 and the network rules 132 in order to select an appropriate communication mode for connecting the sender 102 to the receiver 104. A detailed description of this process will be described in detail below with respect to FIG. 2. The receiver rules 130 may be stored within a receiver profile 128 associated with the receiver 104. It should be appreciated that the repository 126 may be a database that is separate and remote from the communication management server 122, or may be a memory location within the communication management server 122.

Turning now to FIG. 2, an illustrative routine 200 will be described for establishing network communications between the sender communication device 108 and the receiver communication device 110 utilizing the communication management server 122 to manage the modes of communication according to various embodiments presented herein. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination.

The routine 200 begins at operation 202, where the network communication application 124 receives a communication request from the sender 102 over a first communication transport. The request is to establish a communication link with the receiver 104. As stated above, this communication request may originate from the sender communication application 112 or from a communication application 114, 116, 118. From operation 202, the routine 200 continues to operation 204, where the network communication application 124 determines presence information associated with the receiver 104. To determine the presence information, the network communication application 124 requests the information from the repository 126 where the presence information may be stored and updated within the receiver profile 128. Alternatively, the network communication application 124 may request the presence information from a third party element that is operative to track and update the presence information.

From operation 204, the routine 200 continues to operation 206, where the network communication application 124 determines whether there are any communication rules included with the communication request from the sender 102. The sender 102 may transmit a general request such as for an audio only, live conversation. Although the sender 102 uses a telephone to communicate with the sender, the network communication application 124 may select any communication mode associated with the receiver 104 that allows for real-time voice communications based on the presence information and/or a receiver rule 130. Alternatively, the sender 102 may select a specific communication mode for use without any substitution by the network communication application 124. For example, the sender 102 may know that the receiver 104 is available on both a business telephone and a cellular telephone. The sender 102 may choose to contact the receiver 104 on the cellular telephone rather than on the business telephone.

The routine 200 continues from operation 206 to operation 208, where the network communication application 124 determines whether there are any receiver rules 130 established by the receiver 104 or any network rules 132 that apply to the current communication attempt. The receiver 104 may establish a receiver profile 128. Within the receiver profile 128, the receiver 104 can create rules for receiving communications. Because parties receiving a communication decide whether or not to accept the communication, according to one embodiment, the receiver rules 130 have a higher priority than any sender rules or network rules 132. In doing so, the receiver 104 may determine whether or not to receive certain communications and the circumstances under which the communications are to be received.

Using the receiver profile 128, the receiver 104 may group potential senders 102 together and dictate how their presence information is shared with the group. For example, the receiver 104 may establish a receiver rule 130 that allows for a certain group of coworkers to be able to contact the receiver 104 on a desk telephone or via IM from 8:00 AM to 5:00 PM, Monday through Friday. Similarly, a receiver rule 130 may be established that mandates that audio communications from a certain group of friends be directed to voicemail during work hours.

Additionally, the repository 126 may include any number of network rules 132 to be used by the network communication application 124 in selecting a communication mode for establishing a communication link between the sender 102 and the receiver 104. The network rules 132 may be established by a manager of the communication modalities management system 100. According to one implementation, the network rules 132 are used by the network communication application 124 when there are no conflicting sender communication mode requests or conflicting receiver rules 130. For example, a scenario in which the network communication application 124 may use an applicable network rule 132 may occur when the sender 102 may want to reach the receiver 104 through a particular communication mode and communication type, but does not care which communication application 114, 116, 118, communication transport, or communication devices that is used to contact the receiver 104. In this situation, a network rule 132 may instruct the network communication application 124 to initiate the appropriate communication application 114, 116, 118, on the receiver communication device 110 according to the presence information associated with the receiver 104.

Returning to FIG. 2, from operation 208, the routine 200 continues to operation 210, where the network communication application 124 determines whether communication is possible between the sender 102 and the receiver 104 according to any sender rules, receiver rules 130, and/or network rules 132. If the network communication application 124 determines that communication is not possible according to the applicable communication rules, then the routine 200 proceeds to operation 212, where the network communication application 124 returns an error message to the sender communication device 108 and the routine 200 ends. An example of a situation in which communication may not be possible according to the communication rules includes when a sender 102 mandates that communication with the receiver 104 occur via a particular communication mode and the mandated communication mode is not available based on presence information associated with the receiver 104.

However, at operation 210, if the network communication application 124 determines that communication is possible according to the applicable communication rules, then the routine 200 proceeds to operation 214, where the network communication application 124 translates the communication to a second communication transport, if applicable, according to the communication rules. It should be noted that communication may be possible even though the applicable communication rules conflict. If the rules conflict, then according to one implementation, the receiver rules 130 are given priority over any sender rules or network rules 132. At operation 214, the network communication application 124 may be required to translate the communication from the first communication transport associated with the communication medium used to transmit the communication from the sender 102 to the second transport associated with the communication medium corresponding to the selected communication mode for transmitting the communication to the receiver 104. For example, an IM from the sender 102 may be translated for delivery to an SMS application on the receiver communication device 110. From operation 214, the routine 200 continues to operation 216, where the network communication application 124 establishes a communication link between the sender 102 and the receiver 104 and the routine 200 ends.

Turning now to FIGS. 3A and 3B, a GUI 300 used by the sender 102 to request a communication mode for contacting the receiver 104 according to various embodiments presented herein will be described. FIG. 3A shows a GUI 300 that includes communication mode options for four different contacts 302. Each contact 302 has one or more icons displayed. The icons represent the four different communication modes in which all communication devices, methods and transports have been categorized. Specifically, the GUI 300 includes audio/visual icons 304, audio only icons 306, text icons 308, and visual only icons 310.

According to one embodiment, when the sender 102 launches the sender communication application 112 to initiate a communication link with the receiver 104, the network communication application 124 provides the sender 102 with the GUI 300. An icon will be displayed for a given contact 302 if a network address book includes contact information associated with a receiver communication device 110 corresponding to the communication mode represented by the icon. For example, looking at the GUI 300, an audio/visual icon 304 is not displayed for Larry because the network address book does not have any contact information corresponding to an audio/visual device associated with Larry.

Alternatively, according to another embodiment, when the sender 102 launches the sender communication application 112 to initiate a communication link with the receiver 104, the sender communication application 112 provides the sender 102 with the GUI 300. An icon will be displayed for a given contact 302 if the sender 102 has applicable contact information within a local address book or contact list rather than utilizing a network address book. In this embodiment, the sender communication application 112 must query the network communication application 124 for receiver presence information, or alternatively, the sender 102 will not be made aware of the receiver presence information and the network communication application 124 will determine the presence information upon receiving the communication request from the sender 102.

In order to initiate a communication, the sender 102 may click on any of the icons corresponding to the desired communication mode. For example, to place an audio call to Larry, the sender 102 may click on the corresponding audio only icon 306. The sender 102 may get directed to Larry's voicemail if the cached communication type is all that is available. However, depending on the presence information associated with the receiver 104 and any receiver rule 130, the call may be routed to a cellular telephone because Larry is in his car and no longer at his desk.

When the sender 102 wants to request or mandate a specific communication mode and communication type, the sender may move the mouse curser over the desired communication mode icon. A pop-up 312 will list the available communication modes for both communication types, real-time and cached. As seen in FIG. 3A, the sender 102 may choose to initiate a video chat with Jill for a real-time audio/visual communication, or to initiate a video mail to send Jill a cached audio/visual communication. The selections that are included within the pop-up 312 correspond to any populated fields in the network address book or local address book. However, as seen in the pop-up 314 of FIG. 3B, if the receiver 104 has dictated a particular mode of communication, the sender will be notified and will not have a choice of communication modes. For example, in FIG. 3B, the sender may choose to initiate an audio/visual communication with Jill, but Jill has decided whether it will be real-time or cached and via a specific communication mode.

FIG. 3C illustrates a GUI 320 used by the sender 102 to request a communication type for contacting the receiver 104 according to an alternative embodiment. Rather than providing the sender 102 with the audio/visual icons 304, audio only icons 306, text icons 308, and visual only icons 310 representing four different communication modes as shown in FIGS. 3A and 3B, the sender communication application 112 provides the sender 102 with the GUI 320, which includes a list of contacts 322, as well as real-time icons 324 and cached icons 326 corresponding to two different communication types for each contact 322. When the sender 102 clicks on or positions the mouse curser over the desired communication type for the desired receiver 104, then a pop-up 328 will list the available communication modes for the selected communication type.

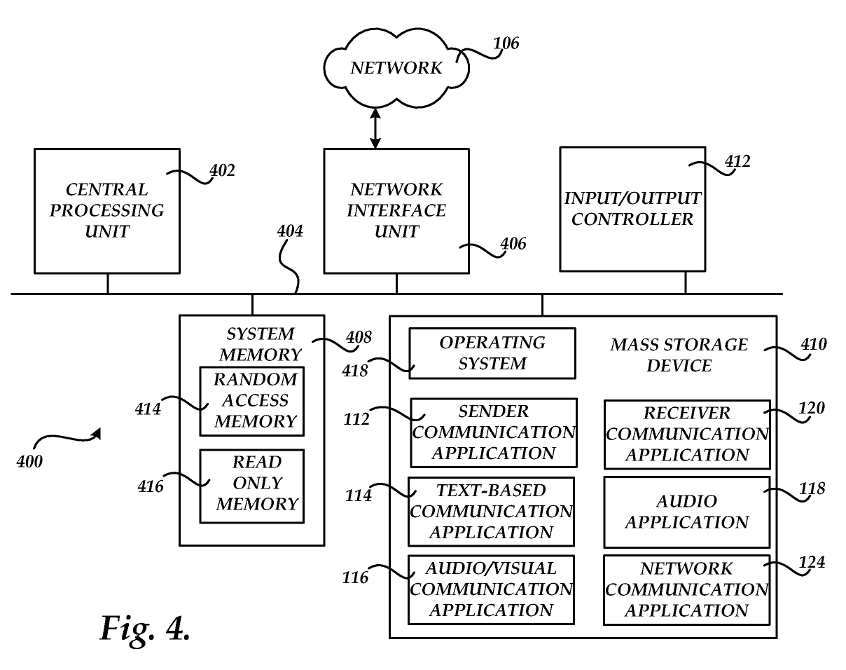

Referring now to FIG. 4, an illustrative computer architecture for a computer 400 utilized in the various embodiments presented herein will be discussed. The computer architecture shown in FIG. 4 illustrates a conventional desktop, laptop computer, or server computer. The computer architecture shown in FIG. 4 includes a central processing unit 402 (CPU), a system memory 408, including a random access memory 414 (RAM) and a read-only memory (ROM) 416, and a system bus 404 that couples the memory to the CPU 402. A basic input/output system (BIOS) containing the basic routines that help to transfer information between elements within the computer 400, such as during startup, is stored in the ROM 416. The computer 400 further includes a mass storage device 410 for storing an operating system 418, application programs, and other program modules, which will be described in greater detail below.

The mass storage device 410 is connected to the CPU 402 through a mass storage controller (not shown) connected to the bus 404. The mass storage device 410 and its associated computer-readable media provide non-volatile storage for the computer 400. Although the description of computer-readable media contained herein refers to a mass storage device, such as a hard disk or CD-ROM drive, it should be appreciated by those skilled in the art that computer-readable media can be any available media that can be accessed by the computer 400.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium which can be used to store the desired information and which can be accessed by the computer 400.

According to various embodiments, the computer 400 may operate in a networked environment using logical connections to remote computers through the network 106. As described above with respect to FIG. 1, the network 106 may include a wireless network such as, but not limited to, a WLAN such as a WI-FI network, a WWAN, a WPAN such as BLUETOOTH, a WMAN such a WiMAX network, a cellular network, or a satellite network. Alternatively, the network 106 may be a wired network such as, but not limited to, a wired WAN, a wired LAN such as the Ethernet, a wired PAN, or a wired MAN. The network 106 may include the Internet such that the elements of the communication modalities management system 100 communicate with one another via wireless or wired connections to the Internet.

The computer 400 may connect to the network 106 through a network interface unit 406 connected to the bus 404. It should be appreciated that the network interface unit 406 may also be utilized to connect to other types of networks and remote computer systems. The computer 400 may also include an input/output controller 412 for receiving and processing input from a number of other devices, including a keyboard, mouse, or electronic stylus (not shown in FIG. 4). Similarly, an input/output controller may provide output to a display screen, a printer, or other type of output device (also not shown in FIG. 4).

As mentioned briefly above, a number of program modules and data files may be stored in the mass storage device 410 and RAM 414 of the computer 400, including the operating system 418 suitable for controlling the operation of a networked desktop or server computer, such as the WINDOWS XP or WINDOWS VISTA operating systems from MICROSOFT CORPORATION of Redmond, Wash. Other operating systems, such as the LINUX operating system or the OSX operating system from APPLE COMPUTER, INC. may be utilized. It should be appreciated that the implementations presented herein may be embodied using a desktop or laptop computer or any other computing devices or systems or combinations thereof.

The mass storage device 410 and RAM 414 may also store one or more program modules. In particular, the mass storage device 410 and the RAM 414 may store the sender communication application 112, the text-based communication application 114, the audio/visual communication application 116, the audio application 118, the receiver communication application 120, and the network communication application 124, as well as any other program modules described above with respect to FIG. 1. Based on the foregoing, it should be appreciated that apparatus, systems, methods, and computer-readable media for managing communication modes to enable network communications are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for enabling communications between a sender device and a receiver device, comprising:
receiving a communication request from the sender device;
selecting a communication mode from a plurality of potential communication modes for communicating with the receiver device according to at least one communication rule; and
establishing a communications link between the sender device and the receiver device utilizing the selected communication mode.

2. The method of claim 1, wherein the communication request comprises a sender communication rule corresponding to a desired communication mode.

3. The method of claim 2, wherein the sender communication rule corresponding to the desired communication mode further corresponds to a desired conversation type.

4. The method of claim 3, further comprising:
providing the sender with a graphical user interface (GUI), the GUI comprising a plurality of communication mode selections associated with the receiver; and
providing the sender with a real-time conversation type selection and a cached conversation type selection for each communication mode selection.

5. The method of claim 1, further comprising determining presence information associated with the receiver and wherein the at least one communication rule designates the communication mode according to the presence information.

6. The method of claim 1, wherein the at least one communication rule comprises a receiver communication rule established by the receiver and a sender communication rule established by the sender, and wherein selecting a communication mode for communicating with the receiver according to at least one communication rule comprises:
determining whether the receiver communication rule and the sender communication rule can both be satisfied to select the receiver device;
if the receiver communication rule and the sender communication rule can both be satisfied, then selecting the communication mode according to the receiver communication rule and the sender communication rule; and
if the receiver communication rule and the sender communication rule cannot both be satisfied to select the communication mode, then selecting the communication mode according to the receiver communication rule.

7. The method of claim 1, further comprising:
determining presence information associated with the receiver; and
determining that the communication mode has not been identified by the receiver and has not been identified by the sender,
wherein the at least one communication rule comprises instructions to determine the communication mode according to the presence information associated with the receiver.

8. The method of claim 1, further comprising determining presence information associated with the receiver, wherein the communication request comprises a request for a real-time conversation with the receiver via any available communication mode, and wherein selecting the communication mode for communicating with the receiver according to at least one communication rule comprises selecting a communication mode operative to communicate in real-time according to the presence information.

9. The method of claim 1, wherein the communication request is received on a first transport from the sender device, wherein selecting the communication mode comprises selecting a second transport associated with the receiver device, and wherein establishing a communications link between the sender device and the receiver device comprises translating the communication request from a format compatible with the first transport to a format compatible with the second transport and transmitting the communications request to the receiver device.

10. The method of claim 1, wherein the at least one communication rule comprises a receiver communication rule established by the receiver.

11. The method of claim 1, wherein the at least one communication rule comprises a sender communication rule comprising the communication mode request.

12. The method of claim 1, wherein the at least one communication rule comprises a network communication rule.

13. A computer-readable medium having computer-executable instructions stored thereon which, when executed by a computer, cause the computer to:
receive a communication request from a sender device;
select a communication mode for communicating with a receiver according to at least one communication rule; and
establish a communications link between the sender device and a receiver device utilizing the selected communication mode.

14. The computer-readable medium of claim 13, wherein the communication request comprises a sender communication rule corresponding to a desired communication mode and to a desired conversation type.

15. The computer-readable medium of claim 14, further comprising computer-executable instructions stored thereon which, when executed by a computer, cause the computer to:
provide the sender with a GUI, the GUI comprising a plurality of communication mode selections associated with the receiver; and
provide the sender with a real-time conversation selection and a cached conversation selection for each communication mode selection.

16. The computer-readable medium of claim 13, further comprising computer-executable instructions stored thereon which, when executed by a computer, cause the computer to determine presence information associated with the receiver and wherein the at least one communication rule designates the communication mode according to the presence information.

17. The computer-readable medium of claim 13, wherein the at least one communication rule comprises a receiver communication rule established by the receiver and a sender communication rule established by the sender, and wherein causing the computer to select a communication mode for communicating with the receiver according to at least one communication rule comprises causing the computer to:
determine whether the receiver communication rule and the sender communication rule can both be satisfied to select the communication mode;
if the receiver communication rule and the sender communication rule can both be satisfied, then to select the communication mode according to the receiver communication rule and the sender communication rule; and
if the receiver communication rule and the sender communication rule cannot both be satisfied to select the communication mode, then to select the communication mode according to the receiver communication rule.

18. The computer-readable medium of claim 13, further comprising computer-executable instructions stored thereon which, when executed by a computer, cause the computer to determine presence information associated with the receiver, wherein the communication request comprises a request for a real-time conversation with the receiver via any available communication mode, and wherein causing the computer to select the communication mode for communicating with the receiver according to at least one communication rule comprises causing the computer to select a communication mode operative to communicate in real-time according to the presence information.

19. The computer-readable medium of claim 13, wherein the at least one communication rule comprises a receiver communication rule established by the receiver.

20. The computer-readable medium of claim 13, wherein the at least one communication rule comprises a sender communication rule comprising the communication mode request.

21. The computer-readable medium of claim 13, wherein the at least one communication rule comprises a network communication rule.

22. A system for enabling communications between a sender and a receiver, comprising:
means for receiving a communication request from a sender device;
means for selecting a communication mode for communicating with the receiver according to at least one communication rule; and
means for establishing a communications link between the sender device and a receiver device utilizing the selected communication mode.

23. The system of claim 22, wherein the communication request comprises a sender communication rule corresponding to a desired mode for communicating with the receiver and to a desired conversation type, the system further comprising:
means for providing the sender with a GUI, the GUI comprising a plurality of communication mode selections associated with the receiver; and
means for providing the sender with a real-time conversation selection and a cached conversation selection for each communication mode selection.

24. The system of claim 22, further comprising means for determining presence information associated with the receiver and wherein the at least one communication rule designates the communication mode according to the presence information.

25. The system of claim 22, wherein the at least one communication rule comprises a receiver communication rule established by the receiver and a sender communication rule established by the sender, and wherein the means for selecting a communication mode for communicating with the receiver according to at least one communication rule comprises:
means for determining whether the receiver communication rule and the sender communication rule can both be satisfied to select the communication mode;
if the receiver communication rule and the sender communication rule can both be satisfied, then means for selecting the communication mode according to the receiver communication rule and the sender communication rule; and
if the receiver communication rule and the sender communication rule cannot both be satisfied to select the communication mode, then means for selecting the communication mode according to the receiver communication rule.

26. The system of claim 22, further comprising means for determining presence information associated with the receiver, wherein the communication request comprises a request for a real-time conversation with the receiver via any available communication mode, and wherein the means for selecting the communication mode for communicating with the receiver according to at least one communication rule comprises means for selecting a communication mode operative to communicate in real-time according to the presence information.

27. The system of claim 22, wherein the at least one communication rule comprises at least one of a receiver rule, a sender rule, or a network rule.

28. A sender communication device for communicating with a plurality of receiver communication devices associated with a receiver, comprising:
a display;
a communication application operative to provide the display with a GUI, the GUI comprising a plurality of communication mode selections associated with the plurality of receiver communication devices and to provide the sender with a real-time conversation type selection and a cached conversation type selection for each communication mode selection; and
a processor operative to execute the communication application.
